(19) United States
(12) Patent Application Publication
(10) Pub. No.: US 2026/0370674 A1
(43) Pub. Date: Nov. 19, 2026

(54) IDENTIFYING MISSING OR ROGUE ASSETS BASED ON AUTONOMOUS PENTESTING

(71) Applicant: Horizon 3 AI, Inc., Dover, DE (US)

(72) Inventors: Snehal Antani, San Francisco, CA (US); Anthony Pillitiere, Wesley Chapel, FL (US); Brian Marr, Nesbit, MS (US)

(21) Appl. No.: 19/209,411

(22) Filed: May 15, 2025

(51) Int. Cl. H04L 9/40

(52) U.S. Cl. CPC H04L 63/1433; H04L 63/1416

(57) ABSTRACT

An autonomous pentesting agent may execute an autonomous pentest of a network including first network assets and identify a presence of the first network assets within the network. The agent may compare the first network assets to second network assets included in a record of configurations associated with the network and identify mismatches between the first network assets and the second network assets. The mismatches may include an absence of one or more first network assets of the first network assets from the second network assets and/or an absence of one or more second network assets of the second network assets from the first network assets. The agent may modify an event logging or a security monitoring operation of the network associated with the configurations to account for the one or more first network assets or the one or more second network assets based on the mismatches.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support identifying missing or rogue assets based on autonomous pentesting.

In some aspects, the techniques described herein relate to a method for managing network asset misconfigurations via autonomous pentesting, including: executing an autonomous pentest of a network including a first plurality of network assets, the autonomous pentest including identifying a presence of the first plurality of network assets within the network; comparing the first plurality of network assets identified via the autonomous pentest to a second plurality of network assets included in a record of one or more configurations associated with the network, wherein the first plurality of network assets and the second plurality of network assets are at least partially different; identifying, based at least in part on the comparing, one or more mismatches between the first plurality of network assets and the second plurality of network assets, wherein the one or more mismatches include one or more of: an absence of one or more first network assets of the first plurality of network assets from the second plurality of network assets, or an absence of one or more second network assets of the second plurality of network assets from the first plurality of network assets; and modifying an event logging or a security monitoring operation of the network associated with the one or more configurations to account for the one or more first network assets or the one or more second network assets based at least in part on the one or more mismatches.

In some aspects, the techniques described herein relate to an apparatus for managing network asset misconfigurations via autonomous pentesting, including: one or more memories storing processor-executable code; and one or more processors coupled with the one or more memories and individually or collectively operable to execute the code to cause the apparatus to: execute an autonomous pentest of a network including a first plurality of network assets, the autonomous pentest including identifying a presence of the first plurality of network assets within the network; compare the first plurality of network assets identified via the autonomous pentest to a second plurality of network assets included in a record of one or more configurations associated with the network, wherein the first plurality of network assets and the second plurality of network assets are at least partially different; identify, based at least in part on the comparing, one or more mismatches between the first plurality of network assets and the second plurality of network assets, wherein the one or more mismatches include one or more of: an absence of one or more first network assets of the first plurality of network assets from the second plurality of network assets, or an absence of one or more second network assets of the second plurality of network assets from the first plurality of network assets; and modify an event logging or a security monitoring operation of the network associated with the one or more configurations to account for the one or more first network assets or the one or more second network assets based at least in part on the one or more mismatches.

In some aspects, the techniques described herein relate to a non-transitory computer-readable medium storing code for managing network asset misconfigurations via autonomous pentesting, the code including instructions executable by one or more processors to: execute an autonomous pentest of a network including a first plurality of network assets, the autonomous pentest including identifying a presence of the first plurality of network assets within the network; compare the first plurality of network assets identified via the autonomous pentest to a second plurality of network assets included in a record of one or more configurations associated with the network, wherein the first plurality of network assets and the second plurality of network assets are at least partially different; identify, based at least in part on the comparing, one or more mismatches between the first plurality of network assets and the second plurality of network assets, wherein the one or more mismatches include one or more of: an absence of one or more first network assets of the first plurality of network assets from the second plurality of network assets, or an absence of one or more second network assets of the second plurality of network assets from the first plurality of network assets; and modify an event logging or a security monitoring operation of the network associated with the one or more configurations to account for the one or more first network assets or the one or more second network assets based at least in part on the one or more mismatches.

### BRIEF DESCRIPTION OF THE DRAWINGS

FIG. 1 shows an example of a computing environment that supports identifying missing or rogue assets based on autonomous pentesting in accordance with aspects of the present disclosure.

FIG. 2 shows an example of an autonomous pentest map that supports identifying missing or rogue assets based on autonomous pentesting in accordance with aspects of the present disclosure.

FIGS. 3 and 4 show examples of computing environments that support identifying missing or rogue assets based on autonomous pentesting in accordance with aspects of the present disclosure.

FIG. 5 shows an example of a flow diagram that supports identifying missing or rogue assets based on autonomous pentesting in accordance with aspects of the present disclosure.

FIG. 6 shows a diagram of a system including a device that supports identifying missing or rogue assets based on autonomous pentesting in accordance with aspects of the present disclosure.

FIG. 7 shows a flowchart illustrating methods that support identifying missing or rogue assets based on autonomous pentesting in accordance with aspects of the present disclosure.

### DETAILED DESCRIPTION

Some networks may use or include a Security Information and Event Management (SIEM) system, a Configuration Management Database (CMDB), or both. For example, as part of an observability system (e.g., a SIEM system and/or a CMDB), a network may store a record of network assets of the network. The network may use the record to collect security-related data and detect threats at each network asset via the SIEM system, manage configuration(s) of each network asset (e.g., hardware configurations, software configurations, network configurations, etc.) via the CMDB, or both. In some cases, the record may include one or more inaccuracies or omissions. For example, assets that are part of the network may not be accounted for in the record, assets that are included in the record but not actually part of the network, or both. Network assets that are present in the network but absent from the record may represent a security risk, as security-related data may not be collected from the network assets via the SIEM system and/or configuration(s) of the network assets may be unmanaged via the CMDB. A security team of the network may manually audit the record by identifying network assets in the network, comparing the identified network assets with the record, and identifying mismatches. However, manual auditing may be time consuming and error-prone, as a human may fail to identify one or more assets within the network, inaccurately identify network assets as matches, and so on.

As described herein, an autonomous pentesting agent may use information obtained via autonomous pentesting of the network to update the record. For example, the autonomous pentesting agent may scan or otherwise identify network assets of the network during an autonomous pentest. The autonomous pentesting agent may compare the identified network assets with network assets in the record of the network (e.g., a record of the SIEM system, the CMDB, or both) and, based on the comparison, identify one or more mismatches. In some examples, the autonomous pentesting agent may automatically update the record based on the one or more mismatches and/or automatically perform remediation in the network, such as isolating unrecorded network assets from one or more other network assets or removing unrecorded network assets from the network. Additionally, or alternatively, the autonomous pentesting agent may perform updates and/or remediation after alerting a user of the network of the one or more mismatches and/or receiving approval of one or more recommended operations. By updating the record, the network may account for network assets previously unmonitored or unmanaged in event logging and/or security monitoring. Accordingly, the autonomous pentesting agent may improve performance of the event logging and/or security monitoring and, thus, improve a security posture of the network.

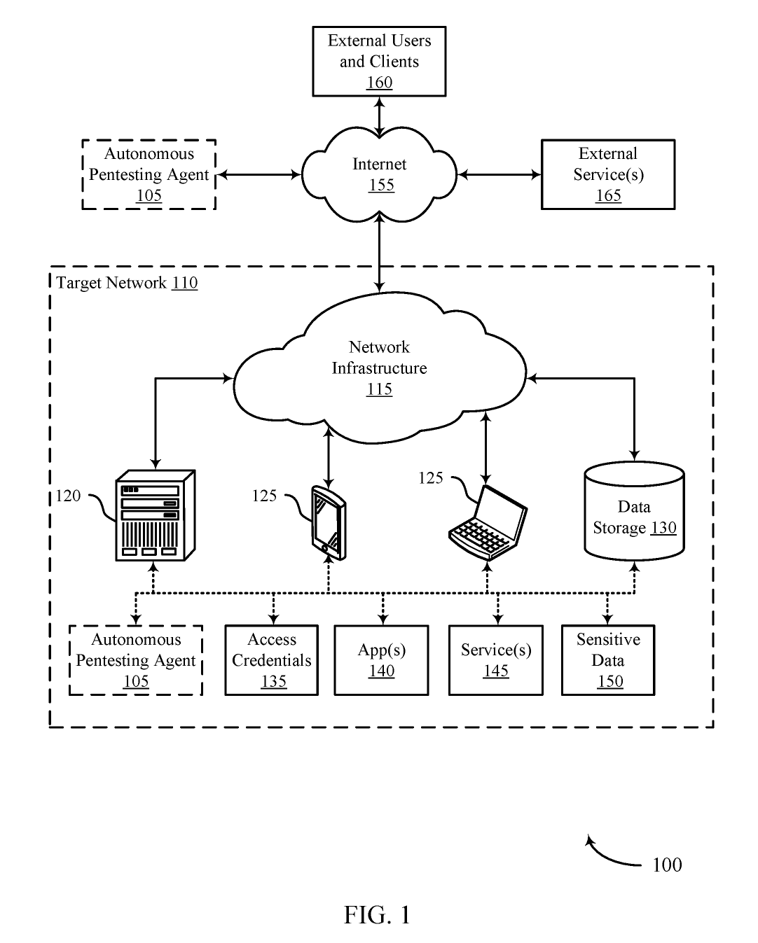

FIG. 1 illustrates an example of a computing environment 100 that supports identifying missing or rogue assets based on autonomous pentesting in accordance with aspects of the present disclosure. The computing environment 100 may include an autonomous pentesting agent 105 that performs an autonomous pentest of a target network 110. The target network 110 may include one or more devices or systems, such as a network infrastructure 115, server 120, computing devices 125, data storage 130, or any combination thereof. The devices or systems of the target network 110 may be configured to access or provide various network information and services, such as access credentials 135, app(s) 140, service(s) 145, sensitive data 150, or any combination thereof.

The target network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the target network 110 as well as communication between the target network 110 (e.g., the private network) and the Internet 155 or other external network (outside the target network 110, beyond a firewall associated with the target network 110, etc.). The target network 110 may include aspects of one or more wired networks, one or more wireless networks (e.g., cellular networks, Wi-Fi networks), or any combination thereof. The target network 110 may include aspects of one or more public networks or private networks, as well as secured or unsecured networks, or any combination thereof. For example, the target network 110 may be an example of a private network that includes one or more public-facing or external assets that are accessible via the Internet 155. As an example, the Internet 155 may refer to the world wide web, and users (e.g., external users and clients 160), may access the target network 110 via the Internet 155 through a website or application that is accessible or available via the Internet 155. For instance, the external users and clients 160, the external service(s) 165, or both may access network information and services via the Internet 155, including the access credentials 135, app(s) 140, service(s) 145, and sensitive data 150.

The target network 110 may be, or may be part of, a domain, such as a private domain associated with an organization, company, client, business, etc., defining an administrative boundary of the target network 110. The domain may include components such as computing devices 125, the server 120, etc., along with associated users (e.g., access credentials 135) and services 145 that are governed or configured by one or more domain controllers and operate in accordance with policies that are put in place and managed by the one or more domain controllers. The domain may be divided into multiple subdomains or groups containing respective subsets of components, users (e.g., access credentials 135), and services 145 that operate in accordance with a respective policy (e.g., group policy).

The target network 110 may be accessible via one or more hosts. For example, hosts may be examples of real or virtual machines that are connected to and capable of accessing the target network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the target network 110 and outside of the network (e.g., with devices accessible via the Internet 155). For example, the server 120 may send data to and receive data from one or more of the computing devices 125. Additionally, or alternatively, hosts may access resources of the target network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to data, devices, or components of the target network 110, including data, software, and hardware. In some examples, network assets may refer to machines that include network shares. For example, network assets may be examples of machines (e.g., real or virtual machines) that include shares of the target network 110, such as file sharing systems. Network assets may be obtained and utilized by attackers to compromise the target network 110. In some cases, network assets may refer to network entities (e.g., system hosts or machines) that have internet protocol (IP) addresses and may be discovered during scans. The server 120, the computing devices 125 (e.g., laptops, desktops, mobile devices, smart vehicles, wearables), the data storage 130, and the access credentials 135, app(s) 140, service(s) 145, cookies, encryption and decryption keys, tokens, and sensitive data 150 accessible via the devices and systems of the target network 110 may all be examples of network assets. Other examples of network assets include virtual machines, printers, Internet-of-Things (IoT) devices, switches, routers, access points, public static IPs, Functions as a Service (FaaS) endpoints (e.g., of serverless architectures), containerized applications (e.g., Kubernetes), and container orchestration platforms (e.g., Amazon Web Service (AWS)). For example, physical devices (e.g., servers, computing devices, data storage) and systems may be considered network assets as well as information, apps, and services accessible through physical devices and systems of the target network 110.

Hosts may store, provide, or implement access credentials 135, app(s) 140, service(s) 145, sensitive data 150, or any combination thereof. In some cases, computing devices 125 on the network may access one or more network assets (credentials 135, app(s) 140, service(s) 145, sensitive data 150, etc.) via the server 120 (e.g., via a host). Additionally, or alternatively, computing devices 125 may locally store or otherwise access one or more network assets of the target network 110. For example, users of the target network 110 may access app(s) 140 and service(s) 145 via the computing devices 125 directly or indirectly (e.g., via a connection between the computing devices 125 and the server 120).

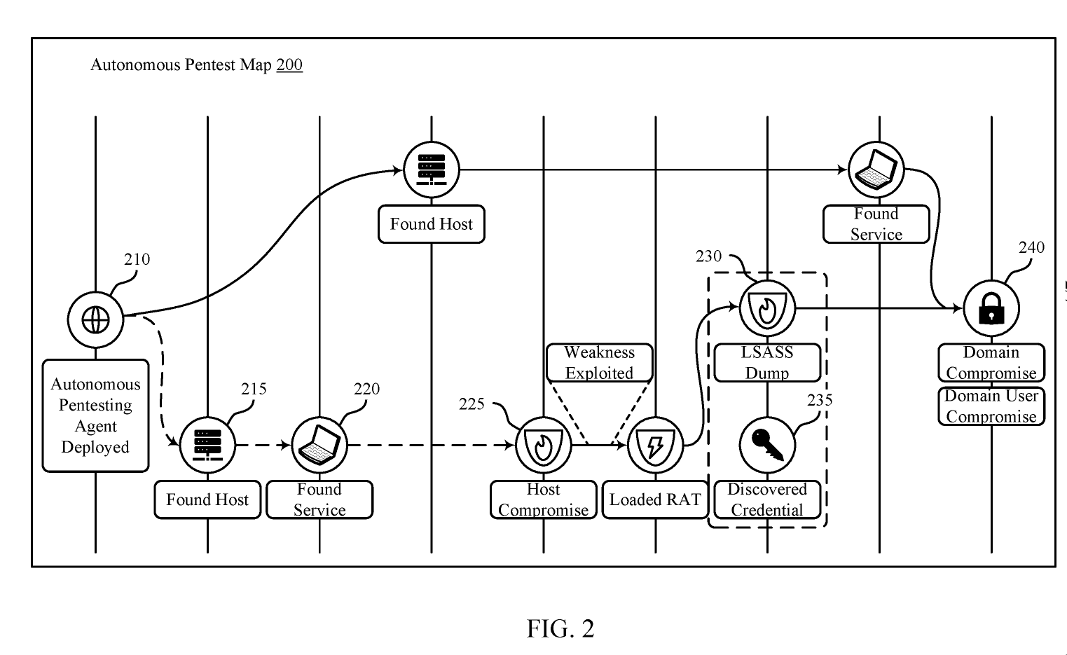

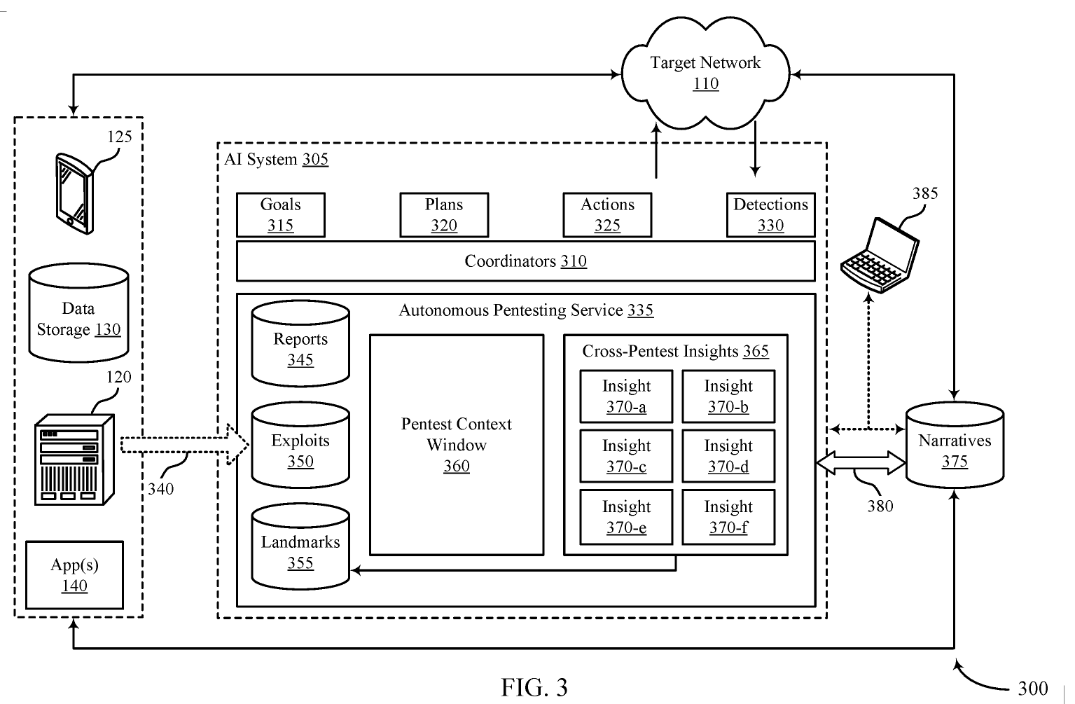

The autonomous pentesting agent 105 may perform a pentest of the target network 110. As used herein, a penetration test or a “pentest” may refer to the performance of one or more security operations that emulate a cybersecurity attack in order to identify security weaknesses in the target network 110. The autonomous pentesting agent 105 may perform the pentest of the target network 110 using or implementing one or more artificial intelligence (AI) models. For example, the autonomous pentesting agent 105 may be “autonomous” in that the autonomous pentesting agent 105 may perform the pentest without hard-coding (e.g., deterministic coding), user inputs, or the like and, instead, by using the one or more AI models. The autonomous pentesting agent 105 may identify, via the pentest, security vulnerabilities of the target network 110. An example of an output of the pentest may be described in greater detail elsewhere herein, including with reference to FIGS. 2 and 3.

The autonomous pentesting agent 105 may, via the one or more AI models, determine and implement an attack path for a pentest. For example, the autonomous pentesting agent 105 may identify or select an asset of the target network 110 to attempt to access or exploit initially and then pivot or laterally move to another asset within the target network 110. This continuous loop of enumerating network assets, assessing weaknesses, exploiting weaknesses, and pivoting or laterally moving between network assets may provide an understanding of the likelihood and impact a threat actor may have in the target network 110. In other words, the autonomous pentesting agent 105 may use the one or more AI models to generate (e.g., output) decisions or operations that mimic those of a potential cyber attacker. The one or more AI models may output a targeted asset of the target network 110 to be subject to an access attempt by the autonomous pentesting agent 105 based on inputs and relevant context of various assets in the target network 110. For instance, the one or more AI models may output targeted assets based on the relative position of assets within the target network 110, asset types, downstream assets (e.g., accessible after or through accessing a targeted asset), or the like.

The one or more AI models may be trained using data of previous pentests of the target network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the target network 110 previously, on other networks, or both. The autonomous pentesting agent 105 may perform improved pentests after the one or more AI models are trained using previous pentests of the target network 110. That is, as the autonomous pentesting agent 105 learns more about the target network 110, the autonomous pentesting agent 105 may perform pentests with higher performance levels (higher accuracy, higher quantities of potential attack paths, etc.).

In some cases, the pentest may be initiated internal (e.g., within) or external to (e.g., outside of a firewall) the target network 110. For example, the autonomous pentesting agent 105 may be deployed at a host device of the target network 110 (e.g., deployed to the server 120 or computing devices 125). In such cases, the autonomous pentesting agent 105 may perform the pentest as an internal user of the target network 110. Such internal pentests may be indicative of or emulate internal security threats to the network, such as from employees of an organization or an attacker that has otherwise access to the target network 110 internally or to a user of the target network 110. Alternatively, the autonomous pentesting agent 105 may be deployed beyond the perimeter of the target network 110 (e.g., via the Internet 155). For example, the autonomous pentesting agent 105 may perform the pentest as an external user of the target network 110, such as by accessing external or public-facing assets of the target network 110 on the Internet 155. In some examples, the autonomous pentesting agent 105 may be deployed via a runner. For example, a runner may be an executable process, script, or sequence, that enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105 (such as in accordance with a pentest schedule).

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the target network 110 against cybersecurity attacks relative to hard-coded (e.g., deterministic) or manual (e.g., human operated) pentests.

As described herein, the autonomous pentesting agent 105 may identify mismatches between a reality of assets in the target network 110 and network assets system administrators, Information Technology (IT) Operations, and/or security teams are tracking or monitoring in one or more systems of record, such as a CMDB. . For example, during an autonomous pentest of the target network 110, the autonomous pentesting agent 105 may identify multiple network assets. The autonomous pentesting agent 105 may compare the multiple network assets to one or more systems of record, of the target network 110 and identify network assets absent from the record, network assets absent from the target network 110, or both. Based on the mismatches between assets in the target network 110 and the record, the autonomous pentesting agent 105 may modify an event logging or security monitoring operation (e.g., at a SIEM system and/or a CMDB) to account for assets that were missing from the record and/or remove assets that were not found in the target network 110.

By auditing the record of the one or more configurations of the target network 110 via autonomous pentesting, the autonomous pentesting agent 105 may improve record-keeping capabilities of the SIEM system and/or the CMDB that includes the one or more configurations. For example, the autonomous pentesting agent 105 may improve an accuracy of the record by ensuring that the assets identified during autonomous pentesting are included and may be monitored. Improving an accuracy of assets included in the record may improve an accuracy of event logging, security monitoring, or both. That is, by auditing the record to ensure that network assets in the target network 110 are accounted for and subject to one or more configurations, the autonomous pentesting agent 105 may improve a capability of the event logging, security monitoring operations, and/or IT operations to ensure control of all network assets operating within the target network 110, identify misconfigurations, detect emerging security threats, or the like. As an example, a system, such as an autonomous security platform, the autonomous pentesting agent 105, or a SIEM system may, using a security monitoring operation, detect an emerging security threat at a device that was identified by the autonomous pentesting agent 105 in an audit. Accordingly, the system may address the security threat at the device prior to escalation to a compromise event.

Additionally, the autonomous pentesting agent 105 may generate recommendations to address security risks associated with unrecorded network assets. For example, based on a context of a network asset within the target network 110, the autonomous pentesting agent 105 may generate a prioritized recommendation for remediation addressing the network asset, modifying the event logging or security monitoring operation to account for the network asset, or both. That is, the autonomous pentesting agent 105 may output respective recommendations associated with unrecorded network assets in an order from highest to lowest risk such that a user of the target network 110 may implement security recommendations addressing the highest risk network assets first.

Additionally, or alternatively, the autonomous pentesting agent 105 may implement automatic remediation and/or modification of the event logging or security monitoring for network assets above a configured severity level. For example, for high-risk network assets, the autonomous pentesting agent 105 may automatically perform remediation that prevents an unrecorded, high-risk network asset from being used to access other network assets and/or compromise the target network 110.

FIG. 2 shows an example of an autonomous pentest map 200 that supports identifying missing or rogue assets based on autonomous pentesting in accordance with aspects of the present disclosure. The autonomous pentest map 200 may be an example of an output or result of an autonomous pentest performed by an autonomous pentesting agent, such as a pentest performed by the autonomous pentesting agent 105 in the target network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the target network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support autonomous auditing of a record of network assets of the network. For example, the autonomous pentesting service may identify network assets during a pentest and compare the identified network assets to the record of network assets to identify errors in the record. The autonomous pentesting service may generate prioritized recommendations for update(s) to the record and/or remediation operations based on risk levels of network assets associated with errors. For example, the autonomous pentesting service may identify that a host involved in the host identification 215 event is absent (e.g., missing or rogue) from the record. Because the host was included in an attack path involving a host compromise 225 event and access 240 to the domain (e.g., domain compromise), the autonomous pentesting service may prioritize recommendations associated with the host over recommendations associated with network assets not involved in projected attacks and/or pentesting attacks. Additionally, or alternatively, the autonomous pentesting service may implement automatic remediation (e.g., without approval via user input), such as isolating the host from other network assets (e.g., such that the host cannot be used to achieve domain compromise).

FIG. 3 shows an example of a computing environment 300 that supports identifying missing or rogue assets based on autonomous pentesting in accordance with aspects of the present disclosure. The computing environment 300 may implement or be implemented by the computing environment 100, the autonomous pentest map 200, or both. For example, the computing environment 300 may include servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions (e.g., from the perspective of a potential cyber attacker). In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing and may be used by the AI system 305. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously (e.g., through the use of AI agents), at least for some operations, to achieve specified goals, make decisions, and take actions without direct human intervention. In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may include an autonomous pentesting service 335 and may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a target network 110, compromise (such as by obtaining unauthorized access or deploying unauthorized software to) a domain or a network asset of the target network 110, or any combination thereof. To obtain the goals 315, the AI system 305 may generate one or more plans 320 that are based on actions 325 and detections 330. For example, to determine a next action within a defined set of guardrails or instructions, the AI system 305 may generate a plan 320 that can include an action 325 to invoke (e.g., execute) one or more commands on a target network 110 to obtain a detection 330 from the target network 110.

In some examples, the target network 110 may include one or more network assets such as servers 120, computing devices 125, data storages 130, app(s) 140, or any combination thereof. Further, obtaining a detection 330 from the target network 110 may include the AI system 305 retrieving telemetry data from the one or more network assets of the target network 110. In some cases, telemetry data obtained from the target network 110 may include logs, traces, metrics, events, or any combination thereof from the one or more network assets of the target network 110. For example, a detection 330 may include some data that is obtained from the target network 110 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 110, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, billions, or trillions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 that resulted in the action 325 succeeding or failing, or any combination thereof. Therefore, the AI system 305 may continuously obtain and update the training data used for training AI/ML models and perform reinforcement learning using collective intelligence to improve the weights and training of the AI/ML models.

In some examples, the training data for the AI system 305 may include telemetry data obtained from the target network 110, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 110) to assist the AI system 305 to navigate and map an environment of the target network 110 during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by providing the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 110, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentesting operations, including successfully exploited vulnerabilities, accessed systems and data, attempted but failed exploit paths, attack paths, among others.

The AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in software (e.g., commonly used enterprise or commercial software). In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant compromise of the target network 110. Therefore, the cross-pentest insights 365 may indicate one or more insights 370 that represent patterns and vulnerabilities that occur across different networks and testing scenarios, helping organizations better understand systemic security weaknesses and how to address such weaknesses. For example, the cross-pentest insights 365 may be added as landmarks 355 for further training the AI system 305 to perform autonomous pentests.

The cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a target network 110. In another example, a narrative 375 may be a presentation for a company or organization that indicates the one or more vulnerabilities in a target network 110 associated with the company or organization. For example, the presentation can indicate the cross-pentest insights 365 obtained from performing one or more autonomous pentests on the target network 110 associated with the company or organization (e.g., the target network 110).

In some examples, users or devices external to the target network 110 may interact, communicate, or otherwise engage with the AI system 305 to configure pentesting parameters, perform pentesting operations on the target network 110, or analyze the results from a pentest on target network 110. For instance, a user such as a service provider for the AI system 305 may operate an external device 385 to provide information to the AI system 305 (e.g., to the coordinators 310), which identifies goals 315, plans 320, or actions 325 for pentesting the target network 110. Additionally, or alternatively, the AI system 305 may provide information, such as cross-pentest insights 365, to the external device 385. A user of the external device 385 may analyze the cross-pentest insights 365 to generate or modify narratives 375 corresponding to the results of the pentest on the target network 110. In some cases, an output of the LLM used to generate narratives 375 may be sent to the external device 385, and a user (e.g., a service provider) of the external device 385 may aggregate narratives 375 about the target network 110 for reporting or conveyance via the pentest context window 360. Alternatively, the user of the external device 385 may modify one or more narratives 375 based on goals 315, plans 320, detections 330, or other information such that the narratives 375 resulting from the pentest for the target network indicate the relevant and important information for identifying weaknesses and addressing vulnerabilities in the target network 110.

An autonomous pentesting service may utilize the AI system 305 to generate prioritized recommendations for modifications to an event logging or security monitoring operation, remediation operations, or both. For example, the AI system 305 may analyze a context of a network asset within the target network 110. In an output to a user associated with the target network 110, the AI system 305 may include an ordered list of recommendations associated with network assets from highest risk to lowest risk. That is, the AI system 305 may analyze which assets—if left unmonitored or without application of remediation operations—may pose highest risk of compromise event(s) to the target network 110 and order recommendations within an output provided to a user accordingly.

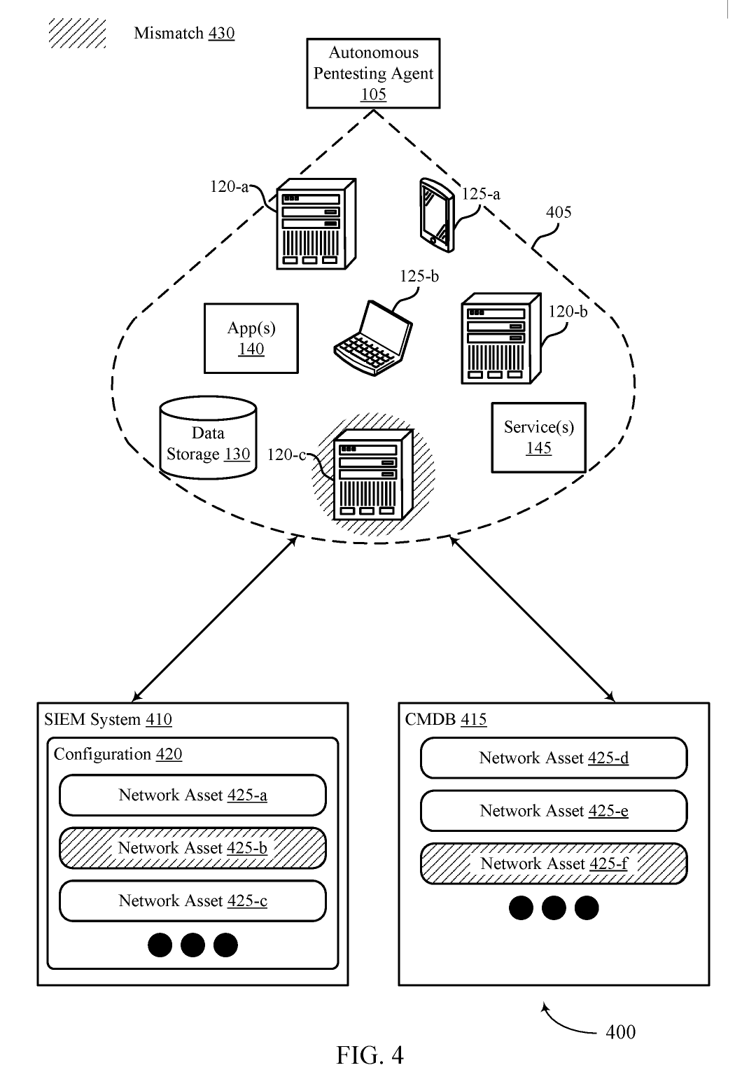

FIG. 4 shows an example of a computing environment 400 that supports identifying missing or rogue assets based on autonomous pentesting in accordance with aspects of the present disclosure. The computing environment 400 may implement or be implemented by the computing environment 100, the autonomous pentest map 200, the computing environment 300, or any combination thereof. The computing environment 400 illustrates an autonomous pentest of a target network conducted by an autonomous pentesting agent 105. The target network may comprise an enterprise network, a cloud-based virtual network, a hybrid infrastructure, or an operational technology (OT) network. The autonomous pentesting agent 105 may access the target network either internally (e.g., as a container or service running within the environment) or externally via authenticated API-based access, depending on deployment architecture. The target network may include multiple network assets, which may be examples of the server 120, the computing devices 125, the app(s) 140, the service(s) 145 or any combination thereof as described with reference to FIG. 1.

The autonomous pentesting agent 105 may perform a scan 405 of the target network and, based on the scan 405, identify network assets within the target network. For example, the autonomous pentesting agent 105 may identify a presence of a server 120-a, a computing device 125-a, app(s) 140, a computing device 125-b, a server 120-b, data storage 130, a server 120-c, and service(s) 145. Although specific types of assets are illustrated and described with reference to FIG. 4, other types of network assets—such as the network assets described with reference to FIG. 1—may also be included in the target network and identified via the scan 405. For example, the network assets may include hosts (e.g., servers, endpoints, IoT devices), credentials (e.g., user accounts, service accounts), data stores (e.g., databases, file shares), or the like. The autonomous pentesting agent 105 may obtain information about the network assets during the scan 405 and/or via other autonomous pentesting operations. Specifically, the autonomous pentesting agent 105 may capture asset details, including Internet Protocol (IP) addresses, host names, credentials, and associated services.

The autonomous pentesting agent 105 may compare the network assets identified via the scan 405 with network assets included in a record of one or more configurations. For example, the autonomous pentesting agent 105 may compare the identified network assets with network asset records stored by or in a SIEM system 410 and/or in a CMDB 415.

The SIEM system 410 may be an example of a cybersecurity system that collects, analyzes, and correlates security-related data from one or more sources. The SIEM system 410 may detect and respond to emerging threats in the target network via data collection and aggregation, data analysis, threat detection and alerting, incident response, and the like. For instance, the SIEM system 410 may perform a security monitoring operation on the target network according to one or more configurations, such as a configuration 420. The configuration 420 may include asset identifiers (e.g., IP ranges, MAC addresses, hostnames), data collection policies (e.g., log types, telemetry frequency), and rule sets for correlation or alerting. In some examples, the configuration 420 may be updated dynamically based on threat intelligence or external integrations. As shown, the SIEM system 410 may collect security-related data at network assets including a network asset 425-a, a network asset 425-b, and a network asset 425-c according to the configuration 420. In some cases, the SIEM system 410 may collect data using asset-specific configurations, or be configured to monitor all network assets. However, in some cases, the SIEM system 410 may be misconfigured. As an example, the SIEM system 410 may lack a configuration for, and therefore fail to recognize, the server 120-c, which the autonomous pentesting agent 105 identified via the scan 405. As a result, the SIEM system 410 may not collect security-related data for the server 120-c. Additionally, or alternatively, the SIEM system 410 may be configured to monitor a network asset 425-b not found in the target network during the scan 405.

The CMDB 415 may be an example of a centralized repository that stores information about network infrastructure, including hardware and software assets, of the target network. The CMDB 415 may store information about configuration items—which may be examples of network assets (e.g., hardware and/or software assets)—as well as relationships between configuration items. As shown, the CMDB 415 may include information about a network asset 425-d, a network asset 425-e, and a network asset 425-f. While the CMDB 415 may be configured to include information about all network assets within the target network, the CMDB 415 may sometimes be misconfigured. For example, the CMDB 415 may lack information about the server 120-c identified via the scan 405. Additionally, or alternatively, the CMDB 415 may include a network asset 425-f not found in the target network during the scan 405.

By comparing the network assets identified during the scan 405 to network assets in the SIEM system 410 and/or the CMDB 415, the autonomous pentesting agent 105 may identify a mismatch 430. As an example, the autonomous pentesting agent 105 may identify a mismatch 430 in the server 120-c, which may not be included in the SIEM system 410 and/or the CMDB 415. The server 120-c identified during the scan 405 but not recorded, recognized, or monitored by the SIEM system 410 or the CMDB 415 may be an example of a missing or rogue asset. A missing asset may refer to an asset present in the target network (e.g., based on the scan 405) but absent (i.e., missing or unconfigured) from the records of the SIEM system 410 and/or the CMDB 415. A rogue asset may refer to an asset present in the target network (e.g., based on the scan 405) but unmanaged or unauthorized (i.e., rogue) by the SIEM system 410 and/or the CMDB 415. In other words, a rogue asset may refer to a missing asset having a relatively high risk level (e.g., above a threshold). A rogue asset may have a higher probability of being used to achieve one or more compromise events in the target network compared to a missing asset. The probability may be assessed based on factors such as the asset’s location in the network topology, exposure to external interfaces, absence of endpoint protection, or known vulnerabilities based on scanning results.

Additionally, or alternatively, the autonomous pentesting agent 105 may identify a mismatch 430 in the network asset 425-b and the network asset 425-f, which may be included in the SIEM system 410 and the CMDB 415, respectively, but not identified during the scan 405. In some examples, the SIEM system 410 and/or the CMDB 415 may include one or more network assets not present in the target network based on failure to update the SIEM system 410 and/or the CMDB 415 after removal of the one or more network assets from the target network. As an example, the network asset 425-b may be an example of a server retired and replaced by the server 120-c. In such examples, the mismatch 430 between the scan 405 and the configuration 420 may be based on the replacement not being logged in the configuration 420.

The autonomous pentesting agent 105 may determine recommendation(s) based on the mismatch 430. For example, the autonomous pentesting agent 105 may recommend updates to the SIEM system 410 and/or the CMDB 415. Additionally, or alternatively, the autonomous pentesting agent 105 may recommend remediation operation(s).

The recommended updates to the SIEM system 410 and/or the CMDB 415 based on the mismatch 430 may involve updating the configuration 420 of the SIEM system 410 to include the server 120-c, updating the CMDB 415 to include the server 120-c, updating the configuration 420 of the SIEM system 410 to remove the network asset 425-b, and updating the CMDB 415 to remove the network asset 425-f. To update the SIEM system 410 and/or the CMDB 415, the autonomous pentesting agent 105 may interface with either or both of the SIEM system 410 and/or the CMDB 415. For example, the autonomous pentesting agent 105 may update records of network assets to add or remove network assets in accordance with the scan 405 and comparison by interfacing with the SIEM system 410 and/or the CMDB 415.

Recommended remediation operation(s) may include isolating or removing assets absent from the SIEM system 410 and/or the CMDB 415. For example, the autonomous pentesting agent 105 may prevent the server 120-c from communicating with one or more network devices or accessing one or more other network assets while still leaving the server 120-c connected to some network systems, such as systems that allow monitoring of the server 120-c (e.g., endpoint detection and response (EDR) systems). Additionally, or alternatively, the autonomous pentesting agent 105 may disconnect (e.g., remove) the server 120-c from the target network (e.g., prevent the server 120-c from accessing and/or communicating with all other assets of the target network) based on the server 120-c being absent from the SIEM system 410 and/or the CMDB 415. For example, the autonomous pentesting agent 105 may disconnect the server 120-c by making virtual local area network (VLAN) changes, injecting firewall policies to the network, performing EDR containment, and/or via orchestration tooling (e.g., via Kubernetes or AWS Security Groups).

The autonomous pentesting agent 105 may implement the recommendation(s) automatically or transmit a notification to a user associated with the target network indicating the recommendation(s). For example, the autonomous pentesting agent 105 may transmit an alert to the user including the recommendation(s) and indicating the mismatch 430. In some examples, the recommendation(s) may be prioritized within the alert to the user according to asset criticality and threat potential. That is, if the autonomous pentesting agent 105 receives a user input indicating that the server 120-c is a high-priority (e.g., critical) asset, the autonomous pentesting agent 105 may prioritize an indication of the mismatch 430 and recommendation(s) associated with the server 120-c in the alert. User input may be provided via a security management interface, ticketing system integration, or as part of manual tagging in the CMDB. The prioritization logic may also incorporate historical incident response data or classification labels (e.g., ‘critical infrastructure’). Additionally, or alternatively, if the autonomous pentesting agent 105 identifies a possible attack path involving the server 120-c that leads to compromise event(s) or involves compromise of high-priority assets, the autonomous pentesting agent 105 may prioritize the indication of the mismatch 430 and the recommendation(s) associated with the server 120-c in the alert. Alternatively, if the autonomous pentesting agent 105 does not receive input(s) indicating a high priority level of the server 120-c (or receives input(s) indicating a low priority level) and/or if the server 120-c is not identified in one or more attack paths of the pentest, the autonomous pentesting agent 105 may de-prioritize information about the server 120-c in the alert.

In some examples, the autonomous pentesting agent 105 may indicate the mismatch 430 between the network assets identified via the scan 405 and the network assets included in the records of the SIEM system 410 and/or the CMDB 415 via one or more visualization tools. For example, the autonomous pentesting agent 105 may generate and output a visual representation of the mismatch 430. The visual representation may be a table listing identified network assets and indicating whether the identified network assets are included in the SIEM system 410 and/or the CMDB 415, a pie chart indicating a percentage of identified network assets that are included in the SIEM system 410 and/or the CMDB 415, or the like. The visual representation may be part of a dashboard embedded in a web user interface, exported to a file type (e.g., Portable Document Format (PDF) or JavaScript Object Notation (JSON)) that is readable by a targeted recipient, and/or integrated with a third-party visualization service.

In some examples, the autonomous pentesting agent 105 may implement the recommendation(s) after receiving authorization based on the alert. For example, the autonomous pentesting agent 105 may receive an indication that the recommendation(s) are approved (e.g., via user input) after transmitting the notification. In some examples, the authorization may apply to a subset of the recommendation(s). As an example, a user may approve a recommendation associated with the server 120-c (e.g., isolating the server), but not yet approve adding the server 120-c to the SIEM system 410 and/or the CMDB 415.

After implementing the recommendation(s), the autonomous pentesting agent 105 may perform another scan 405 (e.g., another autonomous pentest) to validate the records. That is, the autonomous pentesting agent 105 may perform another scan 405 to validate whether the recommendation(s) (if implemented) addressed the mismatch 430 between the identified assets and the assets included in the SIEM system 410 and/or the CMDB 415. A successful validation scan may confirm that all assets previously flagged as missing or rogue are now properly recorded in the SIEM system 410 and/or the CMDB 415, and that no new discrepancies have emerged. The scan may be accompanied by a summary report highlighting resolution status and any residual anomalies. Additionally, or alternatively, the autonomous pentesting agent 105 may periodically perform a scan 405 of the target network to monitor for and address unrecorded assets.

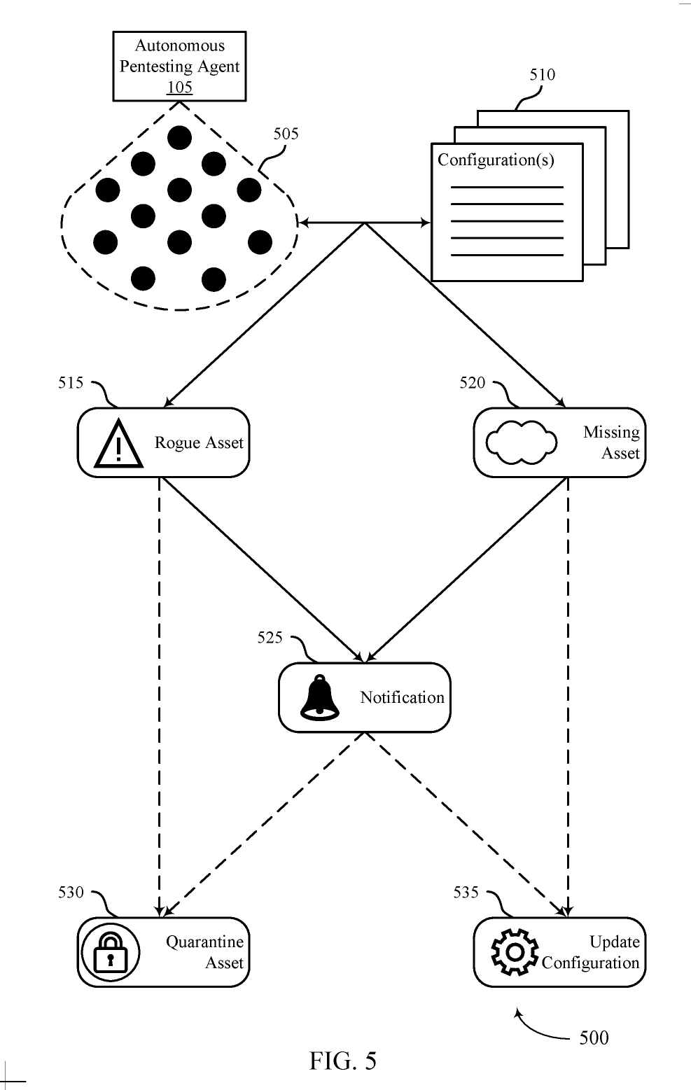

FIG. 5 shows an example of a flow diagram 500 that supports identifying missing or rogue assets based on autonomous pentesting in accordance with aspects of the present disclosure. The flow diagram 500 may implement or be implemented by the computing environment 100, the autonomous pentest map 200, the computing environment 300, the computing environment 400, or any combination thereof. For example, the flow diagram 500 may illustrate operations performed by an autonomous pentesting agent 105 based on a comparison between a scan 505 of a target network and configuration(s) 510 of the target network.

The autonomous pentesting agent 105 may perform the scan 505 of the target network and identify multiple network assets. For example, the autonomous pentesting agent 105 may identify servers, endpoints, and IoT devices. The autonomous pentesting agent 105 may compare the network assets identified via the scan 505 to network assets listed in configuration(s) 510. The configuration(s) 510 may be configurations of an SIEM system or a CMDB, such as the SIEM system 410 or the CMDB 415 as described with reference to FIG. 4. Based on the comparison, the autonomous pentesting agent 105 may determine that a server and an IoT device identified from the scan 505 are missing from the configuration(s) 510. For example, the autonomous pentesting agent 105 may identify that the server is absent from a SIEM configuration and the server and the IoT device are absent from a CMDB record. Accordingly, the autonomous pentesting agent 105 may identify the IoT device as a rogue asset 515 and the server as a missing asset 520.

The autonomous pentesting agent 105 may generate a report recommending updates to the configuration(s) 510 to include the server (e.g., the missing asset 520) and the IoT device (e.g., the rogue asset 515). For example, the autonomous pentesting agent 105 may recommend that a SIEM configuration be updated to include the server and the CMDB record be updated to include both the server and the IoT device. Additionally, the autonomous pentesting agent 105 may flag the IoT device for isolation and investigation. The autonomous pentesting agent 105 may transmit a notification 525 indicating the report (e.g., indicating the recommendations).

In some examples, the autonomous pentesting agent 105 may apply the recommendation(s) immediately (e.g., absent user input in response to the notification 525). Alternatively, the autonomous pentesting agent 105 may apply the recommendation(s) based on receiving authorization in response to the notification 525. For example, the autonomous pentesting agent 105 may quarantine 530 the rogue asset 515 and/or update a configuration 535 to include the missing asset 520 based on identifying the rogue asset 515 and the missing asset 520 and/or based on receiving authorization to implement the recommendation(s).

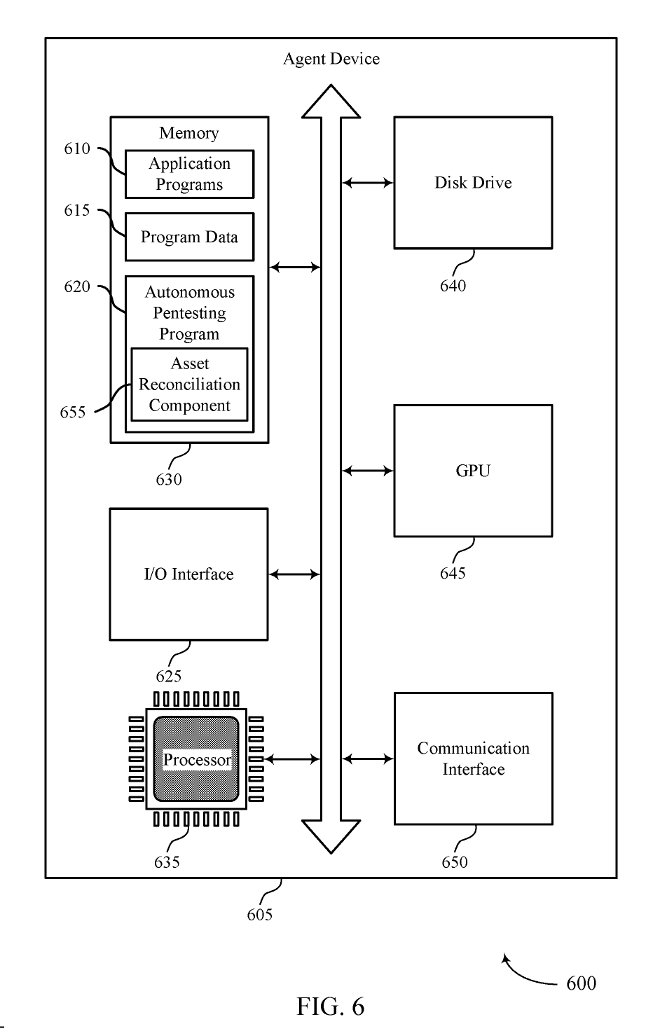

FIG. 6 shows a diagram of a system 600 including an agent device 605 that supports identifying missing or rogue assets based on autonomous pentesting in accordance with aspects of the present disclosure. The agent device 605 may be an example of a device or server on which an autonomous pentesting agent 105 is deployed as described herein. The agent device 605 may include components for identifying missing or rogue assets based on autonomous pentesting, such as a memory 630 including application programs 610, program data 615, an autonomous pentesting program 620, and a asset reconciliation component 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting identifying missing or rogue assets based on autonomous pentesting. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting identifying missing or rogue assets based on autonomous pentesting). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a target network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network accessed by the agent device 605, such as accessed via the communication interface 650. That is, the autonomous pentesting program 620 may be configured to perform an autonomous pentest as described herein, including an autonomous pentest involving managing network asset misconfigurations via autonomous pentesting.

The asset reconciliation component 655 may support managing network asset misconfigurations via autonomous pentesting in accordance with examples as disclosed herein. For example, the asset reconciliation component 655 may be configured as or otherwise support a means for executing an autonomous pentest of a network including a first set of multiple network assets, the autonomous pentest including identifying a presence of the first set of multiple network assets within the network. The asset reconciliation component 655 may be configured as or otherwise support a means for comparing the first set of multiple network assets identified via the autonomous pentest to a second set of multiple network assets included in a record of one or more configurations associated with the network, where the first set of multiple network assets and the second set of multiple network assets are at least partially different. The asset reconciliation component 655 may be configured as or otherwise support a means for identifying, based on the comparing, one or more mismatches between the first set of multiple network assets and the second set of multiple network assets, where the one or more mismatches include one or more of: an absence of one or more first network assets of the first set of multiple network assets from the second set of multiple network assets, or an absence of one or more second network assets of the second set of multiple network assets from the first set of multiple network assets. The asset reconciliation component 655 may be configured as or otherwise support a means for modifying an event logging or a security monitoring operation of the network associated with the one or more configurations to account for the one or more first network assets or the one or more second network assets based on the one or more mismatches.

By including or configuring the asset reconciliation component 655 in accordance with examples as described herein, the agent device 605 may support techniques for improved network security.

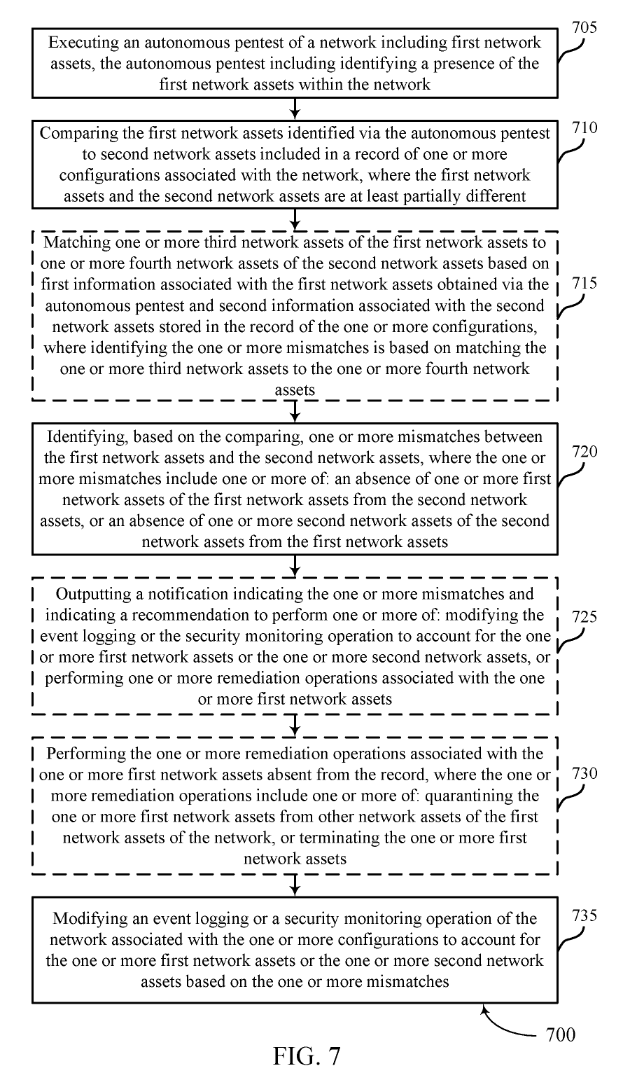

FIG. 7 shows a flowchart illustrating a method 700 that supports identifying missing or rogue assets based on autonomous pentesting in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method 700 may include executing an autonomous pentest of a network including first network assets, the autonomous pentest including identifying a presence of the first network assets within the network.

At 710, the method 700 may include comparing the first network assets identified via the autonomous pentest to second network assets included in a record of one or more configurations associated with the network, where the first network assets and the second network assets are at least partially different.

At 715, the method 700 may include matching one or more third network assets of the first network assets to one or more fourth network assets of the second network assets based on first information associated with the first network assets obtained via the autonomous pentest and second information associated with the second network assets stored in the record of the one or more configurations, where identifying the one or more mismatches is based on matching the one or more third network assets to the one or more fourth network assets.

At 720, the method 700 may include identifying, based on the comparing, one or more mismatches between the first network assets and the second network assets, where the one or more mismatches include one or more of: an absence of one or more first network assets of the first network assets from the second network assets, or an absence of one or more second network assets of the second network assets from the first network assets.

At 725, the method 700 may include outputting a notification indicating the one or more mismatches and indicating a recommendation to perform one or more of: modifying the event logging or the security monitoring operation to account for the one or more first network assets or the one or more second network assets, or performing one or more remediation operations associated with the one or more first network assets.

At 730, the method 700 may include performing the one or more remediation operations associated with the one or more first network assets absent from the record, where the one or more remediation operations include one or more of: quarantining the one or more first network assets from other network assets of the first network assets of the network, or terminating the one or more first network assets.

At 735, the method 700 may include modifying an event logging or a security monitoring operation of the network associated with the one or more configurations to account for the one or more first network assets or the one or more second network assets based on the one or more mismatches.

The following provides an overview of aspects of the present disclosure:

Aspect 1: A method for managing network asset misconfigurations via autonomous pentesting, comprising: executing an autonomous pentest of a network comprising a first plurality of network assets, the autonomous pentest comprising identifying a presence of the first plurality of network assets within the network; comparing the first plurality of network assets identified via the autonomous pentest to a second plurality of network assets included in a record of one or more configurations associated with the network, wherein the first plurality of network assets and the second plurality of network assets are at least partially different; identifying, based at least in part on the comparing, one or more mismatches between the first plurality of network assets and the second plurality of network assets, wherein the one or more mismatches comprise one or more of: an absence of one or more first network assets of the first plurality of network assets from the second plurality of network assets, or an absence of one or more second network assets of the second plurality of network assets from the first plurality of network assets; and modifying an event logging or a security monitoring operation of the network associated with the one or more configurations to account for the one or more first network assets or the one or more second network assets based at least in part on the one or more mismatches.

Aspect 2: The method of aspect 1, further comprising: outputting a notification indicating the one or more mismatches and indicating a recommendation to perform one or more of: modifying the event logging or the security monitoring operation to account for the one or more first network assets or the one or more second network assets, or performing one or more remediation operations associated with the one or more first network assets.

Aspect 3: The method of aspect 2, further comprising: receiving, in response to the notification, approval of updating the record of the one or more configurations, wherein modifying the event logging or the security monitoring operation is based at least in part on the approval.

Aspect 4: The method of aspect 2, further comprising: performing the one or more remediation operations associated with the one or more first network assets absent from the record, wherein the one or more remediation operations comprise one or more of: quarantining the one or more first network assets from other network assets of the first plurality of network assets of the network, or terminating the one or more first network assets.

Aspect 5: The method of aspect 2, wherein the recommendation is based at least in part on respective risk scores associated with each network asset of the one or more first network assets.

Aspect 6: The method of aspect 5, further comprising: identifying one or more attack paths including the one or more first network assets, wherein the one or more attack paths are associated with one or more compromise events and include one or more additional network assets that are downstream from the one or more first network assets; and generating the respective risk scores associated with each network asset of the one or more first network assets in accordance with the one or more compromise events associated with the one or more attack paths and the one or more additional network assets that are downstream from the one or more first network assets.

Aspect 7: The method of any of aspects 1 through 6, further comprising: matching one or more third network assets of the first plurality of network assets to one or more fourth network assets of the second plurality of network assets based at least in part on first information associated with the first plurality of network assets obtained via the autonomous pentest and second information associated with the second plurality of network assets stored in the record of the one or more configurations, wherein identifying the one or more mismatches is based at least in part on matching the one or more third network assets to the one or more fourth network assets.

Aspect 8: The method of any of aspects 1 through 7, wherein the autonomous pentest comprises a scan of the network, and wherein identifying the presence of the first plurality of network assets is based at least in part on the scan.

Aspect 9: The method of any of aspects 1 through 8, wherein the autonomous pentest comprises identifying and storing information associated with each network asset of the first plurality of network assets, the information comprising metadata, one or more IP addresses, one or more hostnames, one or more credentials, one or more privileges, one or more data stores, one or more asset configurations, one or more services, or any combination thereof.

Aspect 10: The method of any of aspects 1 through 9, further comprising: performing a second autonomous pentest of the network to validate updating the record of the one or more configurations.

Aspect 11: The method of any of aspects 1 through 10, wherein the one or more configurations are of a SIEM system, a CMDB, or both.

Aspect 12: The method of any of aspects 1 through 11, wherein the first plurality of network assets, the second plurality of network assets, or both comprise one or more hosts, one or more credentials, one or more data stores, one or more network assets, or any combination thereof.

Aspect 13: An apparatus for managing network asset misconfigurations via autonomous pentesting, comprising: one or more memories storing processor-executable code; and one or more processors coupled with the one or more memories and individually or collectively operable to execute the code to cause the apparatus to perform a method of any of aspects 1 through 12.

Aspect 14: A non-transitory computer-readable medium storing code for managing network asset misconfigurations via autonomous pentesting, the code comprising instructions executable by one or more processors to perform a method of any of aspects 1 through 12.

Aspect 15: An apparatus for managing network asset misconfigurations via autonomous pentesting, comprising at least one means for performing a method of any aspects 1 through 12.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for managing network asset misconfigurations via autonomous pentesting, comprising:
executing an autonomous pentest of a network comprising a first plurality of network assets, the autonomous pentest comprising identifying a presence of the first plurality of network assets within the network;
comparing the first plurality of network assets identified via the autonomous pentest to a second plurality of network assets included in a record of one or more configurations associated with the network, wherein the first plurality of network assets and the second plurality of network assets are at least partially different;
identifying, based at least in part on the comparing, one or more mismatches between the first plurality of network assets and the second plurality of network assets, wherein the one or more mismatches comprise one or more of: an absence of one or more first network assets of the first plurality of network assets from the second plurality of network assets, or an absence of one or more second network assets of the second plurality of network assets from the first plurality of network assets; and
modifying an event logging or a security monitoring operation of the network associated with the one or more configurations to account for the one or more first network assets or the one or more second network assets based at least in part on the one or more mismatches.

2. The method of claim 1, further comprising:
outputting a notification indicating the one or more mismatches and indicating a recommendation to perform one or more of:
modifying the event logging or the security monitoring operation to account for the one or more first network assets or the one or more second network assets, or
performing one or more remediation operations associated with the one or more first network assets.

3. The method of claim 2, further comprising:
receiving, in response to the notification, approval of updating the record of the one or more configurations, wherein modifying the event logging or the security monitoring operation is based at least in part on the approval.

4. The method of claim 2, further comprising:
performing the one or more remediation operations associated with the one or more first network assets absent from the record, wherein the one or more remediation operations comprise one or more of:
quarantining the one or more first network assets from other network assets of the first plurality of network assets of the network, or
terminating the one or more first network assets.

5. The method of claim 2, wherein the recommendation is based at least in part on respective risk scores associated with each network asset of the one or more first network assets.

6. The method of claim 5, further comprising:
identifying one or more attack paths including the one or more first network assets, wherein the one or more attack paths are associated with one or more compromise events and include one or more additional network assets that are downstream from the one or more first network assets; and
generating the respective risk scores associated with each network asset of the one or more first network assets in accordance with the one or more compromise events associated with the one or more attack paths and the one or more additional network assets that are downstream from the one or more first network assets.

7. The method of claim 1, further comprising:
matching one or more third network assets of the first plurality of network assets to one or more fourth network assets of the second plurality of network assets based at least in part on first information associated with the first plurality of network assets obtained via the autonomous pentest and second information associated with the second plurality of network assets stored in the record of the one or more configurations, wherein identifying the one or more mismatches is based at least in part on matching the one or more third network assets to the one or more fourth network assets.

8. The method of claim 1, wherein the autonomous pentest comprises a scan of the network, and wherein identifying the presence of the first plurality of network assets is based at least in part on the scan.

9. The method of claim 1, wherein the autonomous pentest comprises identifying and storing information associated with each network asset of the first plurality of network assets, the information comprising metadata, one or more Internet protocol (IP) addresses, one or more hostnames, one or more credentials, one or more privileges, one or more data stores, one or more asset configurations, one or more services, or any combination thereof.

10. The method of claim 1, further comprising:
performing a second autonomous pentest of the network to validate updating the record of the one or more configurations.

11. The method of claim 1, wherein the one or more configurations are of a security information and event management (SIEM) system, a configuration management database (CMDB), or both.

12. The method of claim 1, wherein the first plurality of network assets, the second plurality of network assets, or both comprise one or more hosts, one or more credentials, one or more data stores, one or more network assets, or any combination thereof.

13. An apparatus for managing network asset misconfigurations via autonomous pentesting, comprising:
one or more memories storing processor-executable code; and
one or more processors coupled with the one or more memories and individually or collectively operable to execute the code to cause the apparatus to:
execute an autonomous pentest of a network comprising a first plurality of network assets, the autonomous pentest comprising identifying a presence of the first plurality of network assets within the network;
compare the first plurality of network assets identified via the autonomous pentest to a second plurality of network assets included in a record of one or more configurations associated with the network, wherein the first plurality of network assets and the second plurality of network assets are at least partially different;
identify, based at least in part on the comparing, one or more mismatches between the first plurality of network assets and the second plurality of network assets, wherein the one or more mismatches comprise one or more of: an absence of one or more first network assets of the first plurality of network assets from the second plurality of network assets, or an absence of one or more second network assets of the second plurality of network assets from the first plurality of network assets; and
modify an event logging or a security monitoring operation of the network associated with the one or more configurations to account for the one or more first network assets or the one or more second network assets based at least in part on the one or more mismatches.

14. The apparatus of claim 13, wherein the one or more processors are individually or collectively further operable to execute the code to cause the apparatus to:
output a notification indicating the one or more mismatches and indicating a recommendation to perform one or more of:
modifying the event logging or the security monitoring operation to account for the one or more first network assets or the one or more second network assets, or
performing one or more remediation operations associated with the one or more first network assets.

15. The apparatus of claim 14, wherein the one or more processors are individually or collectively further operable to execute the code to cause the apparatus to:
receiving, in response to the notification, approval of updating the record of the one or more configurations, wherein modifying the event logging or the security monitoring operation is based at least in part on the approval.

16. The apparatus of claim 14, wherein the one or more processors are individually or collectively further operable to execute the code to cause the apparatus to:
perform the one or more remediation operations associated with the one or more first network assets absent from the record, wherein the one or more remediation operations comprise one or more of:
quarantining the one or more first network assets from other network assets of the first plurality of network assets of the network, or
terminating the one or more first network assets.

17. A non-transitory computer-readable medium storing code for managing network asset misconfigurations via autonomous pentesting, the code comprising instructions executable by one or more processors to:
execute an autonomous pentest of a network comprising a first plurality of network assets, the autonomous pentest comprising identifying a presence of the first plurality of network assets within the network;
compare the first plurality of network assets identified via the autonomous pentest to a second plurality of network assets included in a record of one or more configurations associated with the network, wherein the first plurality of network assets and the second plurality of network assets are at least partially different;
identify, based at least in part on the comparing, one or more mismatches between the first plurality of network assets and the second plurality of network assets, wherein the one or more mismatches comprise one or more of: an absence of one or more first network assets of the first plurality of network assets from the second plurality of network assets, or an absence of one or more second network assets of the second plurality of network assets from the first plurality of network assets; and
modify an event logging or a security monitoring operation of the network associated with the one or more configurations to account for the one or more first network assets or the one or more second network assets based at least in part on the one or more mismatches.

18. The non-transitory computer-readable medium of claim 17, wherein the instructions are further executable by the one or more processors to:
output a notification indicating the one or more mismatches and indicating a recommendation to perform one or more of:
modifying the event logging or the security monitoring operation to account for the one or more first network assets or the one or more second network assets, or
performing one or more remediation operations associated with the one or more first network assets.

19. The non-transitory computer-readable medium of claim 18, wherein the instructions are further executable by the one or more processors to:
receiving, in response to the notification, approval of updating the record of the one or more configurations, wherein modifying the event logging or the security monitoring operation is based at least in part on the approval.

20. The non-transitory computer-readable medium of claim 18, wherein the instructions are further executable by the one or more processors to:
perform the one or more remediation operations associated with the one or more first network assets absent from the record, wherein the one or more remediation operations comprise one or more of:
quarantining the one or more first network assets from other network assets of the first plurality of network assets of the network, or
terminating the one or more first network assets.
